(19) United States
(12) Patent Application Publication
(10) Pub. No.: US 2026/0261767 A1
(43) Pub. Date: Sep. 3, 2026

(54) PROCESSING METHOD, ELECTRONIC DEVICE, APPARATUS, AND COMPUTER-READABLE STORAGE MEDIUM

(71) Applicant: Lenovo (Beijing) Limited, Beijing (CN)

(72) Inventors: Chang LIU, Beijing (CN); Liang SUN, Beijing (CN); Heng CHEN, Beijing (CN); Yanxia LU, Beijing (CN)

(21) Appl. No.: 19/542,766

(22) Filed: Feb. 18, 2026

(30) Foreign Application Priority Data
Feb. 28, 2025 (CN) 202510241019.3

(51) Int. Cl. H04N 23/71; H04N 23/63; H04N 23/73

(52) U.S. Cl. CPC H04N 23/71; H04N 23/632; H04N 23/73

(57) ABSTRACT

A processing method comprising obtaining a first captured image through an image collection apparatus based on a first exposure parameter, the first captured image representing a real scene, analyzing the first captured image, and in response to an analysis result of the first captured image satisfying a trigger condition, obtaining a second captured image through the image collection apparatus based on a second exposure parameter, the second captured image representing the real scene. A preview image based on the first captured image is displayed on a display screen to show the real scene and present a first brightness level. A preview image based on the second captured image is displayed on the display screen to show the real scene and present a second brightness level. The second brightness level is less than the first brightness level.

### CROSS-REFERENCES TO RELATED APPLICATION

The present disclosure claims priority to Chinese Patent Application No. 202510241019.3, filed on Feb. 28, 2025, the entire content of which is incorporated herein by reference.

### FIELD OF TECHNOLOGY

The present disclosure relates to the information technology field and, more particularly, to a processing method, electronic device, apparatus, and computer-readable storage medium.

### BACKGROUND

During capturing an image using an image collection apparatus, when the captured image is overexposed and too bright, a user has to stop capturing and adjust capture parameters manually. During the adjustment process, the user will operate the electronic device where the image collection apparatus is located, and the previously set capturing and composing parameters will be affected.

### SUMMARY

One aspect of this disclosure provides a processing method. The method includes obtaining a first captured image through an image collection apparatus based on a first exposure parameter, the first captured image representing a real scene, analyzing the first captured image, and in response to an analysis result of the first captured image satisfying a trigger condition, obtaining a second captured image through the image collection apparatus based on a second exposure parameter, the second captured image representing the real scene. A preview image based on the first captured image is displayed on a display screen to show the real scene and present a first brightness level. A preview image based on the second captured image is displayed on the display screen to show the real scene and present a second brightness level. The second brightness level is less than the first brightness level.

Another aspect of this disclosure provides an electronic device including a camera, a display screen, and a processor. The camera is configured to capture an image. The display screen is configured to output and display. The processor is configured to control the camera to obtain a first captured image based on a first exposure parameter, the first captured image representing a real scene, analyze the first captured image, and in response to an analysis result of the first captured image satisfying a trigger condition, obtain a second captured image through the image collection apparatus based on a second exposure parameter, the second captured image representing the real scene. A preview image based on the first captured image is displayed on a display screen to show the real scene and present a first brightness level. A preview image based on the second captured image is displayed on the display screen to show the real scene and present a second brightness level. The second brightness level is less than the first brightness level.

Another aspect of this disclosure provides a computer-readable storage medium storing one or more computer programs that, when executed by one or more processors, cause the one or more processors to obtain a first captured image based on a first exposure parameter, the first captured image representing a real scene, analyze the first captured image, and in response to an analysis result of the first captured image satisfying a trigger condition, obtain a second captured image through the image collection apparatus based on a second exposure parameter, the second captured image representing the real scene. A preview image based on the first captured image is displayed on a display screen to show the real scene and present a first brightness level. A preview image based on the second captured image is displayed on the display screen to show the real scene and present a second brightness level. The second brightness level is less than the first brightness level.

### BRIEF DESCRIPTION OF THE DRAWINGS

Through the description of embodiments of the present disclosure with reference to the accompanying drawings, the above and other purposes, features, and advantages of the present disclosure are clearer.

FIG. 1A is a schematic flowchart of a processing method according to some embodiments of the present disclosure.

FIG. 1B is a schematic diagram of an environment light sensor according to some embodiments of the present disclosure.

FIG. 1C is a schematic diagram of a display interface according to some embodiments of the present disclosure.

FIG. 1D is a schematic diagram of another display interface according to some embodiments of the present disclosure.

FIG. 1E is a schematic diagram of another display interface according to some embodiments of the present disclosure.

FIG. 2 is a schematic structural diagram of an electronic device according to some embodiments of the present disclosure.

FIG. 3 is a schematic structural diagram of a processing system according to some embodiments of the present disclosure.

FIG. 4 is a schematic flowchart of a processing method according to some embodiments of the present disclosure.

FIG. 5 is a schematic diagram of another display interface according to some embodiments of the present disclosure.

FIG. 6 is a schematic diagram of another display interface according to some embodiments of the present disclosure.

FIG. 7 is a schematic diagram of a grayscale histogram according to some embodiments of the present disclosure.

FIG. 8 is a schematic diagram of another grayscale histogram according to some embodiments of the present disclosure.

FIG. 9 is a schematic diagram showing a direction of a pitch angle according to some embodiments of the present disclosure.

FIG. 10 is a schematic diagram of a Poisson distribution according to some embodiments of the present disclosure.

FIG. 11 is a schematic structural diagram of a processing apparatus according to some embodiments of the present disclosure.

### DETAILED DESCRIPTION

To make the purposes, technical solutions, and advantages of the present disclosure clearer, the technical solution of the present disclosure can be further described in connection with the accompanying drawings and embodiments of the present disclosure. The described embodiments should not be regarded as limiting the present disclosure. All other embodiments obtained by those of ordinary skill in the art without creative effort shall be within the scope of the present disclosure.

In the following description, the terms “first/second/third” involved are merely to distinguish similar objects and do not represent a specific order for the objects. Understandably, “first/second/third” can, where permissible, be interchanged in a specific sequence or order so that the embodiments of the present disclosure described here can be implemented in an order other than illustrated or described here. Unless otherwise defined, all technical and scientific terms used here have the same meanings as commonly understood by those skilled in the art. The terms used herein are merely for describing the purposes of the present disclosure and are not intended to limit the present disclosure. In addition, to facilitate description, the accompanying drawings only show parts relevant to the present disclosure.

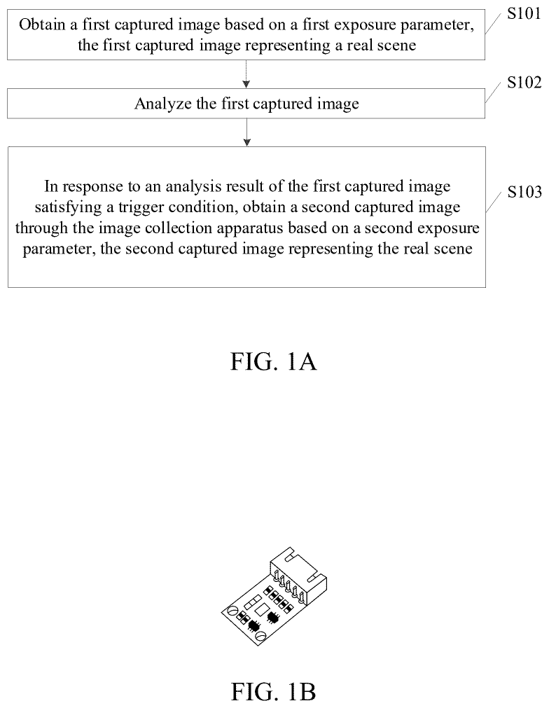

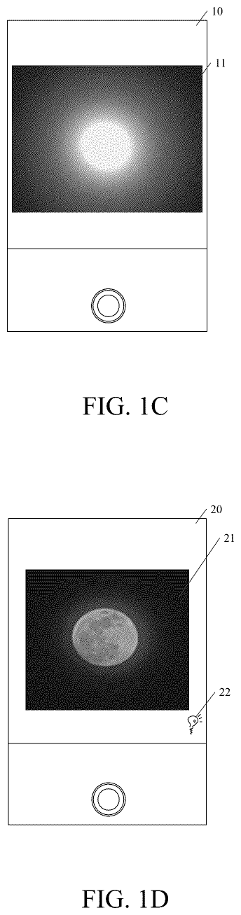

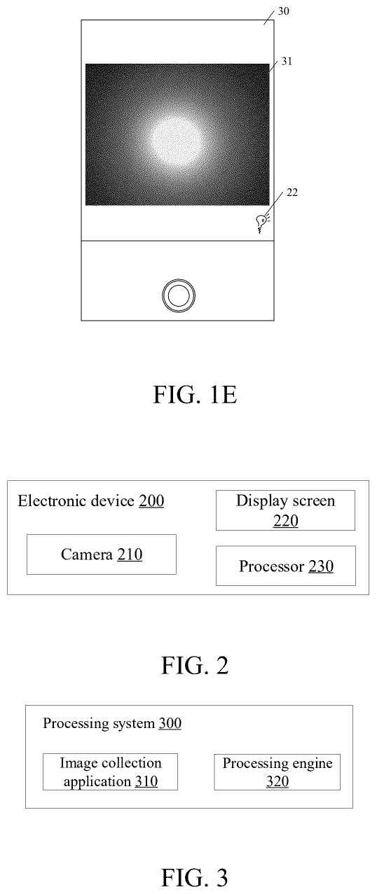

Embodiments of the present disclosure provide a processing method. The method can be executed by an electronic device. The electronic device can refer to a server, laptop computer, tablet computer, desktop computer, smart TV, set-top box, mobile device (e.g., mobile phone, portable video player, personal digital assistant, dedicated messaging device, portable gaming device), or other devices with data processing capabilities. As shown in FIG. 1A, the processing method includes steps S101 to S103.

At S101, a first captured image is obtained by an image collection apparatus (e.g., a camera) based on a first exposure parameter, and the first captured image represents a real scene.

The image collection apparatus can include an apparatus with an image collection function, which can be integrated into the electronic device or externally connected to the electronic device. For example, the image collection apparatus can be a camera.

The first exposure parameter can be an exposure parameter corresponding to the situation when the first captured image is captured through the image collection apparatus. The exposure parameter can include, but is not limited to, at least one of aperture, shutter speed, or sensitivity.

The first captured image can include at least one image or at least one image frame corresponding to a video.

In some embodiments, the first captured image can be displayed on a display module of the electronic device, such as a display screen, or the first captured image may also not be displayed.

The real scene can be the scene corresponding to the real environment in the picture of the first captured image.

At S102, the first captured image is analyzed.

The image information of the first captured image can be analyzed.

In some embodiments, the first captured image can be analyzed based on the image parameter of the first captured image. The image parameter can include, but is not limited to, at least one of pixel grayscale, visual element, or capturing parameter.

Different analysis results can be obtained by analyzing the first captured image from different angles.

At S103, if the analysis result of the first captured image meets a trigger condition, a second captured image is obtained by the image collection apparatus based on a second exposure parameter, and the second captured image represents a real scene.

A preview image based on the first captured image can be displayed on the display screen, showing the real scene with a first brightness level.

A preview image based on the second captured image can be displayed on the display screen, showing the real scene with a second brightness level.

The second brightness level can be less than the first brightness level.

The second exposure parameter can be an exposure parameter corresponding to the situation when the second captured image is captured by the image collection apparatus.

In some embodiments, the second exposure parameter can be a fixed value or a non-fixed value.

The scene corresponding to the real environment of the picture of the second captured image can be the same as the scene corresponding to the real environment of the picture of the first captured image.

For the same scene, the brightness level of the image captured by the image collection apparatus based on the second exposure parameter can be less than the brightness level of the image captured by the image collection apparatus based on the first exposure parameter.

The first brightness level presented by the preview image based on the first captured image can be jointly determined by the pixel brightness level of the preview image based on the first captured image and the brightness level of the display screen. The second brightness level presented by the preview image based on the second captured image can be jointly determined by the pixel brightness level of the preview image based on the second captured image and the brightness level of the display screen. Therefore, when the brightness level of the display screen is unchanged in displaying the preview image based on the first captured image and the preview image based on the second captured image, the pixel brightness level of the preview image based on the second captured image can be lower than the pixel brightness level of the preview image based on the first captured image.

A trigger condition can indicate that the brightness level of the captured image is too high. When the analysis result of the first captured image meets the trigger condition, the image can be captured based on the second exposure parameter, and the second brightness level of the obtained second captured image can be lower than the first brightness level of the first captured image.

The preview image based on the first collection image can be the first captured image displayed on the display screen.

In some embodiments, the second captured image can be displayed on a display module of the electronic device, such as a display screen, and may also not be displayed.

The preview image based on the second captured image can be the second captured image displayed on the display screen.

In some embodiments, after capturing a candidate captured image based on the second exposure parameter, the brightness level of the pixels in the candidate captured image can be identified. Based on the ratio or difference between the maximum pixel brightness level and the minimum pixel brightness level in the candidate captured image, the contrast of the candidate captured image can be determined. When the contrast is greater than a contrast threshold, the brightness level value of the minimum pixel brightness level can be increased to reduce the contrast. Thus, the details of the pixel regions with smaller brightness level can be clearer. When the contrast is less than the contrast threshold, the brightness level value of the pixel with the pixel brightness level greater than the average pixel brightness level can be increased, and the brightness level value of the pixel with the pixel brightness level less than the average pixel brightness level can be decreased. Then, the contrast can be increased, and the image can be more layered.

In some embodiments, the second exposure parameter can be determined based on a shaking degree of the image collection apparatus when capturing the first captured image and the first exposure parameter. Then, when the shaking degree is high, the exposure time can be further reduced to make the image clearer.

In some embodiments, the shaking degree of the image collection apparatus when capturing the first captured image can be determined by an Optical Image Stabilizer (OIS) and/or image recognition. Through OIS, the shaking degree can be quickly obtained with low power consumption. Through image recognition, the shaking degree can be obtained without adding a device assembly.

In embodiments of the present disclosure, by analyzing the first captured image obtained by the image collection apparatus based on the first exposure parameter, when the analysis result meets the trigger condition, the second captured image can be obtained by the image collection apparatus based on the second exposure parameter. The first captured image and the second captured image can represent the same real scene, and the preview image based on the first captured image can present the first brightness level on the display screen, while the preview image based on the second captured image can present the second brightness level lower than the first brightness level on the display screen. Then, on the one hand, by analyzing the first captured image, the exposure parameter of the image collection apparatus can be automatically adjusted when the analysis result meets the trigger condition to complete image capturing of the same real scene under different exposure parameters. On the other hand, since the image brightness level of the image captured based on the second exposure parameter is lower than the image brightness level of the image captured based on the first exposure parameter, while the brightness level of the display screen remains unchanged, the brightness level of the preview image and/or captured image can be automatically reduced. When the image brightness level exceeds the photographing requirement, the user may not need to manually adjust the image brightness level, providing a smoother user experience.

In some embodiments, step S102 includes steps S111 and S112.

At S111, the brightness level of each pixel of the first captured image is counted.

The brightness level of a pixel can be represented by the pixel grayscale.

In some embodiments, based on the grayscale information of the first captured image, the brightness level of each pixel of the first captured image can be counted. The grayscale information can include a grayscale image corresponding to the first captured image and/or a grayscale distribution map of the first captured image.

At S112, numbers of pixels of different brightness levels of the first captured image is obtained.

After counting the brightness level of each pixel of the first captured image, for each brightness level, the number of pixels corresponding to the brightness level can be counted.

In some embodiments, based on the grayscale histogram of the first captured image, the numbers of pixels of different brightness levels of the first captured image can be obtained. Then, the numbers of pixels of different brightness levels of the first captured image can be intuitively obtained.

In embodiments of the present disclosure, by counting the brightness level of each pixel in the first captured image, the numbers of pixels of different brightness levels of the first captured image can be obtained. Thus, based on the numbers of pixels of different brightness levels of the first captured image, the pixel brightness level characteristic of the first captured image can be obtained, and the pixel brightness level characteristic of the first captured image can be further analyzed.

In some embodiments, step S103 includes step S121 when the analysis result of the first captured image meets the trigger condition.

At S121, the first captured image includes target pixels with brightness levels greater than a target brightness level, and a ratio of the target pixels to the pixels of the first captured image is greater than a target threshold.

The target brightness level can be used to characterize the target value of the pixel brightness level and can include a preset pixel brightness level value, e.g., a target grayscale value.

The target threshold can be a preset maximum pixel ratio threshold.

In some embodiments, the ratio of the target pixels to the pixels of the first captured image can include the numerical ratio between the number of the target pixels and the total number of pixels of the first captured image. The target threshold can include a maximum numerical ratio threshold.

Exemplarily, when the target grayscale value is 200, and the maximum numerical ratio threshold between the number of target pixels and the total number of pixels of the first captured image is 3%, if the number of pixels in the first captured image with a grayscale value greater than 200 is 12,000, and the total number of pixels of the first captured image is 480,000, the pixel ratio between the number of target pixels and the total number of pixels of the first captured image is 2.5%, less than 3%. Therefore, the analysis result of the first captured image does not meet the trigger condition.

In embodiments of the present disclosure, when the first captured image includes target pixels greater than the target brightness level, and the ratio of the target pixels to the pixels of the first captured image is greater than the target threshold, the analysis result of the first captured image can be determined to meet the trigger condition. Then, based on the number of target pixels exceeding the target brightness level in the first captured image, the accuracy of determining whether the analysis result of the first captured image meets the trigger condition can be further improved.

In some embodiments, the processing method further includes step S131.

At S131, the second exposure parameter is determined based on the average brightness level of the target pixels greater than the target brightness level.

When the average brightness level of the target pixels greater than the target brightness level is different, the value of the second exposure parameter can be different.

The average brightness level and the second exposure parameter can have a correspondence. That is, each average brightness level value can correspond to a second exposure parameter.

Exemplarily, when the second exposure parameter is the exposure duration, the exposure duration can be set to be inversely proportional to the average brightness level of the target pixels. For example, when the average brightness level is 255, the corresponding exposure duration can be determined to be 1 ms. When the average brightness level is 250, the corresponding exposure duration can be determined to be 1.5 ms. When the average brightness level is 230, the corresponding exposure duration can be determined to be 5 ms, and so on. Then, when the average brightness level is higher, the image brightness level can be further reduced by shortening the exposure duration.

In some embodiments, for each pixel brightness level greater than the target brightness level, a product of the pixel brightness level and the corresponding number of pixels can be obtained. The sum of the obtained products can be divided by the total number of target pixels to obtain a quotient, that is, the average brightness level of the target pixels. Based on the correspondence between the average brightness level of the target pixels and the second exposure parameter, the second exposure parameter corresponding to the average brightness level can be determined.

Exemplarily, the process of obtaining the average brightness level Yₐᵥₐ can refer to formula (1):

$${Y}_{ava} = \frac{\sum [ Y ( {n}_{0} , {n}_{1} , … , {n}_{m} ) * Count ( {n}_{0} , {n}_{1} , … , {n}_{m} ) ]}{[ Count ( {n}_{0} ) + Count ( {n}_{1} ) + … + Count ( {n}_{m} ) ]} \qquad ( 1 )$$

Where, Y(n) denotes the pixel brightness level value greater than the target brightness level, a range of m is [0, 255], and Count(n) is the number of pixels corresponding to the pixel brightness level value greater than the target brightness level.

When capturing images of the same real scene, different zooming magnifications of the scene can be applied while capturing the images. The number of target pixels greater than the target brightness level in the images can be different. That is, the average brightness levels of target pixels greater than the target brightness level can also be different. Therefore, the zooming magnification of the scene during image capturing can also have a correspondence with the second exposure parameter. That is, each zooming magnification can correspond to a respective second exposure parameter.

In embodiments of the present disclosure, the second exposure parameter can be determined based on the average brightness level of the target pixels greater than the target brightness level. Then, according to the pixel brightness level of the first captured image, the adjustment degree of the exposure parameter can be determined to obtain the second exposure parameter. Further, according to the second exposure parameter, the brightness level of the second captured image can be adjusted to improve the correlation between the second brightness level of the second captured image obtained based on the second exposure parameter and the first brightness level of the first captured image, as well as the adaptability to the real scene.

In some embodiments, the above processing method further includes at least one of steps S141 or S142.

At S141, a sensing parameter representing the posture of the electronic device is obtained when the image collection apparatus obtains the first captured image based on the first exposure parameter. The trigger condition further includes the sensing parameter meeting a sensing threshold. The electronic device includes an image collection apparatus.

The sensing parameter can be used to represent the posture and/or posture change of the electronic device.

For example, the sensing parameter can include an accelerometer parameter used to represent a tilt angle of the electronic device.

For another example, the sensing parameter can include a gyroscope parameter used to represent a rotational motion of the electronic device.

For another example, the sensing parameter can include a magnetometer parameter used to represent a heading angle of the electronic device.

For another example, the sensing parameter can include at least one of the tilt angle, motion speed, acceleration, or heading angle of the electronic device.

In some embodiments, the sensing parameters representing the posture of the electronic device can be obtained through motion sensing sensors in the electronic device; among them, the motion sensing sensors can include, but are not limited to, at least one of an accelerometer, a gravity sensor, a gyroscope, or a magnetometer.

Exemplarily, the acceleration of the electronic device along x, y, and z axes can be obtained through an accelerometer. The components of the gravity acceleration along x, y, and z axes can be obtained through a gravity sensor to further obtain the pitch angle of the electronic device.

Different sensing parameters can correspond to different sensing thresholds.

For example, when the sensing parameter is the pitch angle of the electronic device, the minimum threshold corresponding to the pitch angle can be determined as −180° and the maximum threshold corresponding to the pitch angle can be determined as −90°, or the minimum threshold can be determined as 90° and the maximum threshold corresponding to the pitch angle can be determined as 180°.

Then, based on the pitch angle of the electronic device, the type of the real scene captured by the image collection apparatus can be further determined. For example, when the pitch angle of the electronic device indicates that the user captures the scene through the image collection apparatus by looking downward or upward, the trigger condition can be determined to be satisfied. Thus, the exposure parameter of the image collection apparatus can be adjusted from the first exposure parameter to the second exposure parameter to satisfy the scene requirement of the user for the capturing light source for the space or ground.

At S142, the environment brightness level parameter representing the posture of the electronic device is obtained when the image collection apparatus obtains the first captured image based on the first exposure parameter. The trigger condition further includes the environment brightness level parameter meeting an environment brightness level threshold. The environment brightness level parameter is used to determine the brightness level of the display screen.

The environment brightness level parameter can include, but is not limited to, the brightness level parameter of the environment in which the electronic device is located at the corresponding posture when the image collection apparatus obtains the first captured image based on the first exposure parameter. For example, the environment brightness level parameter can be the ambient illuminance of the environment of the electronic device where the image collection apparatus is arranged, when the first captured image is collected by the camera based on the first exposure parameter. That is, the environment brightness level for adjusting the display brightness level can be used as the trigger condition. In embodiments of the present disclosure, the environment where the photographer and the image collection apparatus used by the photographer are located can be fixed. In embodiments of the present disclosure, in the process of capturing and displaying the first captured image based on the first exposure parameter as the preview image through the display screen and capturing and displaying the second captured image based on the second exposure parameter as the preview image through the display screen, the display brightness level can be unchanged.

The trigger condition can include a certain area of a bright region appearing corresponding to a dark scene (e.g., an indoor dark scene or an outdoor dark scene).

In some embodiments, when the environment brightness level parameter meets the environment brightness level threshold, the scene type of the real scene can be determined as the target scene type. The target scene type can indicate that the scene includes at least one light source region. The light source type in the light source region can include, but is not limited to, at least one of a point light source, a line light source, or a surface light source.

For example, when the environment brightness level parameter is less than the minimum brightness level threshold, the environment brightness level of the current real scene can be determined to be low. That is, the electronic device can be in a dark environment. At the same time, since the first captured image indicates that a bright region exists in the image, the first captured image can be considered to include a light source. Further, the brightness level of the light source region in the image can be reduced by adjusting the exposure parameter, so that the light source region is clearly visible in the image.

In some embodiments, the environment brightness level parameter can be obtained through a photosensitive assembly.

Exemplarily, the photosensitive assembly includes an environment light sensor as shown in FIG. 1B.

In some embodiments, the trigger condition can include the environment brightness level parameter being less than the environment brightness level threshold.

Exemplarily, the environment brightness level threshold can be the minimum ambient illuminance, and the minimum ambient illuminance can be 8 lux. When the environment light brightness level is 6 lux when capturing the first captured image, the trigger condition can be considered to be met.

Then, based on the environment brightness level parameter, when the environment when the electronic device is located is determined to be a dark environment, by determining that the trigger condition is met, the exposure parameter of the image collection apparatus can be further adjusted from the first exposure parameter to the second exposure parameter to reduce the possibility of overexposure when the user captures the light source in the dark environment.

By combining two conditions of the sensing parameter of the electronic device and the environment brightness level parameter, the accuracy of determining whether the trigger condition is met can be further improved. Thus, the accuracy of automatically adjusting the exposure parameter to meet user requirements can be improved.

For example, the environment brightness level parameter of the real scene can be less than the environment brightness level threshold, and the pitch angle of the electronic device can be greater than −180° and less than −90°. Then, the real scene can be considered to indicate that the user holds the electronic device in a dark environment and captures toward the sky (e.g., capturing the moon or streetlights in the night sky, or ceiling lights in a dark room). Thus, by combining the sensing parameter of the electronic device and the environment brightness level parameter, the current scene can be more accurately determined, and whether to switch the exposure parameter can be further determined.

For example, the environment brightness level parameter of the real scene can be less than the environment brightness level threshold, the pitch angle of the electronic device can be within a preset range, and the ratio of the target pixels to the pixels of the first captured image can be greater than the target threshold. By combining the above conditions, the user holding the electronic device in the dark environment and capturing toward the sky can be further determined, and the captured scene can include a light source.

In some embodiments, step S101 can include step S151.

At S151, a target number of frames of the first captured image are obtained by the image collection apparatus based on the first exposure parameter.

The target number of frames can be a preset number of frames. The target number of frames of the first captured image captured continuously can indicate the result of capturing the real scene continuously with a plurality of frames.

Exemplarily, 15 frames of the first captured image can be continuously captured by the camera based on the first exposure parameter.

Before obtaining the second captured image by the image collection apparatus based on the second exposure parameter in step S103, the processing method can further include step S152:

At S152, based on the determination result of the trigger condition corresponding to each frame of the target number of frames of the first captured image, the confidence level is determined.

Whether each frame of the target number of frames of the first captured image satisfies the target condition can be determined to further determine the confidence level.

The confidence level can be used to indicate the credibility that the trigger condition can be met when the first captured image is captured by the image collection apparatus based on the first exposure parameter.

In some embodiments, when each frame of the first captured image satisfies any one of the trigger conditions, the frame of the first captured image can be determined to satisfy the trigger condition. In some other embodiments, when each frame of the first captured image satisfies all different trigger conditions, the frame of the first captured image can be determined to satisfy the trigger condition.

In some embodiments, the confidence result corresponding to the first number of frames of the first captured image that meet the trigger condition can be marked as untrustworthy, and the confidence result corresponding to the second number of frames of the first captured image that do not meet the trigger condition can be marked as trustworthy. Further, according to the first number of frames and the second number of frames, the confidence level of the first captured image of the target number of frames can be determined.

For example, the confidence level can be determined according to the proportion of the first number of frames to the target number of frames.

For another example, the confidence level can be determined according to the proportion of the second number of frames to the target number of frames.

For another example, the confidence level can be determined according the first number of frames using a Poisson distribution.

In step S103, obtaining the second captured image by the image collection apparatus based on the second exposure parameter can include step S153.

At S153, in response to the confidence level being greater than a target value, the second captured image is obtained by the image collection apparatus based on the second exposure parameter, and the confidence level being greater than the target value indicates that the photographing of the real scene is in a stable state.

The target value can include the confidence threshold when the photographing of the real scene is in a stable state. The photographing of the real scene being in the stable state can include that the capturing operation of the user capturing the first captured image by the image collection apparatus is in a stable state, and/or the real scene is in a stable state.

In embodiments of the present disclosure, the target number of frames of the first captured images that are collected continuously can be obtained. The confidence level an be determined based on the determination result of the trigger condition corresponding to each frame of the first captured image. When the confidence level is greater than the target value, the second captured image can be obtained by the image collection apparatus based on the second exposure parameter. Then, when photographing of the real scene is in a stable state, the exposure parameter of the image collection apparatus can be adjusted to reduce misadjustment of the exposure parameter caused by changes in the real scene or instability of the user capturing operation. Thus, the stability of adjusting the exposure parameter can be further improved, and the accuracy of the second captured image meeting the user requirements in the real scene can be improved.

In some embodiments, the above processing method can further include steps S161 and S162.

At S161, in response to the confidence level being greater than the target value, a prompt indicator is displayed. The prompt indicator is used to indicate that photographing of the real scene belongs to a target photographing scene.

The prompt indicator can include, but is not limited to, at least one of text, icon, or control.

The target photographing scene can indicate that a high-brightness level region exists in the photographing environment corresponding to the real scene, and the current exposure parameter of the image collection apparatus can be determined as the second exposure parameter.

Through the display of the prompt indicator, the user can determine that the exposure parameter of the image collection apparatus is the second exposure parameter.

At S162, in response to an input operation for the prompt indicator, obtaining the second captured image by the image collection apparatus based on the second exposure parameter is turned off.

The input operation can include at least one of the user trigger operations for a target controller, user voice input, or user trigger operation on a physical button. In some embodiments, the target controller can include the prompt indicator.

By triggering the physical button and/or the target controller, and/or providing a voice command, a turning off instruction can be triggered for obtaining the second captured image by the image collection apparatus based on the second exposure parameter.

Exemplarily, as shown in FIG. 1C, when the user is photographing, the display interface 10 displays the preview image 11. The preview image 11 can correspond to the preview image based on the first captured image in the above processing method.

As shown in FIG. 1D, the preview image 11 is analyzed. Based on the analysis result, if the preview image 11 is determined to meet the target condition, the display interface 20 displays the preview image 21 and the prompt indicator 22. The preview image 21 can correspond to the preview image based on the second captured image in the above processing method, and the prompt indicator 22 can indicate that a high-brightness level region exists in the current photographing scene.

As shown in FIG. 1E, after the user performs an input operation for the prompt indicator 22, the exposure parameter of the image collection apparatus is adjusted from the second exposure parameter to the first exposure parameter. The preview image 31 of the third captured image collected by the image collection apparatus based on the first exposure parameter and the prompt indicator 22 are displayed in the display interface 30.

In embodiments of the present disclosure, in response to the confidence level being greater than the target value, the prompt indicator that is used to indicate that the photographing of the real scene belongs to the target photographing scene can be displayed. In response to the input operation for the prompt indicator, obtaining the second captured image by the image collection apparatus based on the second exposure parameter can be turned off. Thus, the information indicating that the exposure parameter has been adjusted can be provided to the user according to the prompt indicator. Moreover, according to the photographing requirement of the user, obtaining the second captured image based on the second exposure parameter can be turned off to better meet the photographing requirement of the user for the real scene.

Embodiments of the present disclosure provide an electronic device. As shown in FIG. 2, the electronic device 200 includes a camera 210, a display screen 220, and a processor 230.

The camera 210 can be configured to capture an image.

The display screen 220 can be configured to output and display.

The processor 230 can be configured to control the camera to obtain the first captured image based on the first exposure parameter, the first captured image representing the real scene, analyze the first captured image, and if the analysis result of the first captured image meets the trigger condition, control the camera to obtain the second captured image based on the second exposure parameter, the second captured image crepresenting the real scene.

The preview image based on the first captured image can be displayed on the display screen to show the real scene and present the first brightness level.

The preview image based on the second captured image can be displayed on the display screen to show the real scene and present the second brightness level.

The second brightness level can be less than the first brightness level.

In some embodiments, the processor can further be configured to count the brightness levels of each pixel of the first captured image and obtain the number of pixels of different brightness levels in the first captured image.

In some embodiments, the analysis result of the first captured image meeting the trigger condition can include that the first captured image includes target pixels greater than the target brightness level, and the ratio of the target pixels to the pixels of the first captured image is greater than the target threshold.

In some embodiments, the processor can further be configured to determine the second exposure parameter based on the average brightness level of the target pixels greater than the target brightness level. When the average brightness level of the target pixels greater than the target brightness level is different, the value of the second exposure parameter can be different.

In some embodiments, the electronic device can further include a motion sensor. The motion sensor can be configured to obtain the sensing parameter indicating the posture of the electronic device when the camera obtains the first captured image based on the first exposure parameter. The trigger condition can also include the sensing parameter satisfying the sensing threshold, and the electronic device including the camera. Alternatively, the electronic device can further include an environment light sensor. The environment light sensor can be configured to obtain the environment brightness level parameter indicating the posture of the electronic device when the camera obtains the first captured image based on the first exposure parameter. The trigger condition can further include that the environment brightness level parameter satisfies the environment brightness level threshold. The environment brightness level parameter can be used to determine the brightness level of the display screen.

In some embodiments, the processor can further be configured to control the camera to continuously obtain the target number of frames of the first captured image based on the first exposure parameter, before controlling the camera to obtain the second captured image based on the second exposure parameter, determine the confidence level based on the determination result of the trigger condition corresponding to each frame of the target number of frames of the first captured image, and in response to the confidence level being greater than the target value, control the camera to obtain the second captured image based on the second exposure parameter. The confidence level being greater than the target value can indicate that the photographing of the real scene is in a stable state.

In some embodiments, the processor can further be configured to, in response to the confidence level being greater than the target value, control the display screen to display the prompt indicator, the prompt indicator being used to indicate that photographing of the real scene belongs to the target photographing scene, and in response to an input operation for the prompt indicator, turn off obtaining the second captured image by the camera based on the second exposure parameter.

Embodiments of the present disclosure provide a processing system. As shown in FIG. 3, the processing system 300 includes an image collection application 310 and a processing engine 320 associated with specific hardware. The image collection application 310 can be an application with an image collection function, including but not limited to, at least one of a system application, a video-audio application, a gaming application, or a social medium application. The user can capture an image through the image collection application 310. The image collection application 310 can be used to determine the scene type of the real scene, and obtain a sensing parameter of the electronic device where the image collection application 310 is under the real scene from the processing engine 320 and control the processing assembly corresponding to the processing engine 320 by calling the corresponding processing interface. The processing assembly can include but is not limited to at least one of an image collection assembly, an environment brightness level sensing assembly, or a motion sensing assembly. The processing engine 320 can be configured to obtain the sensing parameter of the electronic device where the image collection application 310 is under the real scene and, in response to the calling information of the image collection application 310 for the processing interface, control the corresponding processing assembly to perform the processing operation. Determining the scene type of the real scene can correspond to analyzing the first captured image and determining whether the analysis result meets the trigger condition in the processing method.

In some embodiments, the processing assembly can collect data in real-time and report the data to the processing engine. For example, after the sensing assembly collects sensing data at 2 Hz in real-time, the sensing assembly can report the sensing data in real-time to the processing engine. Thus, the image collection application can obtain the sensing data in real-time through the processing interface and further analyze whether the first captured image meets the trigger condition.

When the user captures an image, a scene with a point light source existing in the captured picture may exist. For example, the captured picture can include streetlights at night, the moon in the sky, etc.

In the related technology, with the exposure adjustment algorithm, the brightness levels of the preview image and captured picture can be raised due to the background of the captured picture being too dark to cause overexposure, which contradicts the user intention to capture the point light source clearly. At the same time, when the user is far away from the captured object (e.g., the point light source), the captured object can be zoomed in in the captured picture through a digital zoom. However, the clarity of the enlarged captured picture can be reduced. With the exposure adjustment algorithm, the brightness levels of the preview image and the captured picture can be further raised again to improve the clarity of the picture to cause the overexposure of the picture to lower the user photographing experience.

In this case, the user often needs to manually operate to switch and control the exposure parameter to adjust the brightness level, which is inconvenient for the photographing process of the user. Meanwhile, since switching and controlling the exposure parameter needs time, the user may not capture the scene corresponding to the required moment in time.

Based on this, based on the processing system 300, embodiments of the present disclosure provide a processing method, which can be executed by the electronic device to automatically adjust the exposure parameter according to the current scene to lower the brightness level of the captured picture. As shown in FIG. 4, the processing method includes steps S401 to S409.

At S401, the user opens the image collection application.

In some embodiments, after the user opens the image collection application, the application can enter a preview stage by default, and the preview image can be displayed in the display interface. The preview image can be the preview image based on the first captured image.

At S402, the image collection application obtains the pixel grayscale histogram of a plurality of consecutive frames of the first captured image and counts overexposed regions.

The pixel grayscale histogram of the first captured image can correspond to the grayscale information of the first captured image in the above processing method.

The overexposed regions can correspond to the regions of the target pixels greater than the target brightness level in the first captured image in the above processing method. By counting the overexposed regions, the number of pixels corresponding to the overexposed regions can be obtained. Then, whether the pixel ratio of the pixel number of the overexposed regions to the pixels of the first captured image is greater than the target threshold can be determined.

In some embodiments, when the pixel ratio of the pixel number of the overexposed regions to the pixels of the first captured image is greater than the target threshold, whether the type of the light source in the real scene meets the light source type corresponding to the trigger condition (e.g., at least one of the real scene including at least one point light source region, the real scene including at least a plurality of point light source regions, the proportion of the light source region in the real scene being greater than the target threshold) can be determined.

In some embodiments, through intelligent dynamic range detection, the number of frames of the first captured image of 15 consecutive frames in which the pixel ratio of the target pixels to the total pixels of the first captured image is greater than 5% can be counted. The pixel grayscale value of the target pixels can be all greater than 230, i.e., the target brightness level, and 5% can be the target threshold.

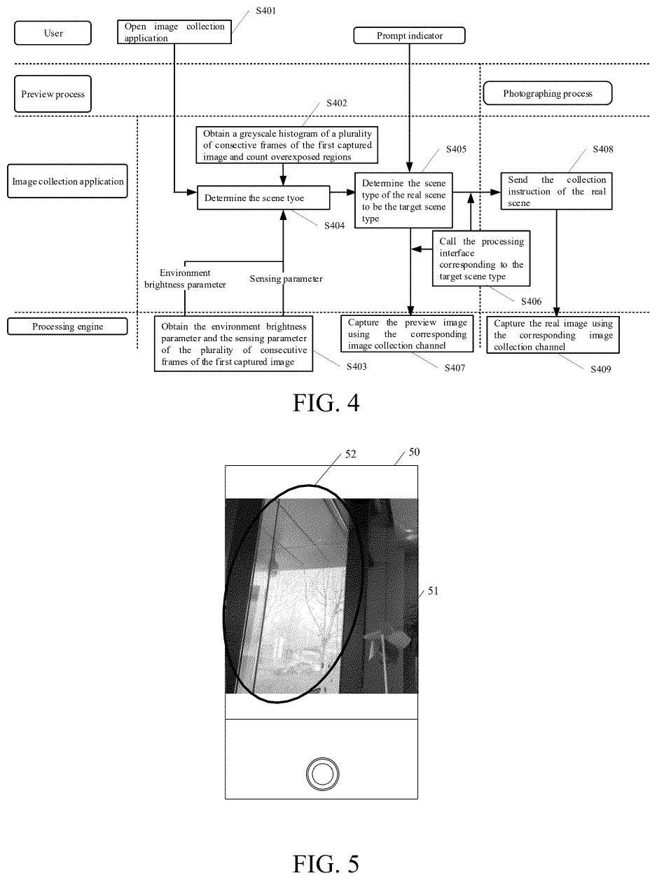

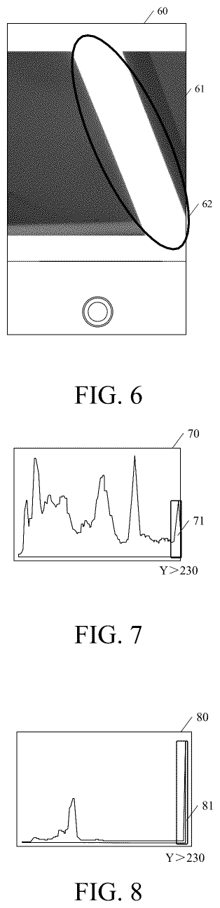

Exemplarily, in connection with FIG. 5, FIG. 6, FIG. 7, and FIG. 8, a preview image 51 is displayed in the display interface 50 of FIG. 5. The light source region corresponding to the real scene represented by the preview image 51 corresponds to a region 52. A preview image 61 is displayed in the display interface 60 of FIG. 6. The light source region corresponding to the real scene represented by the preview image 61 corresponds a region 62. FIG. 7 shows a greyscale histogram 70 corresponding to the preview image 51. FIG. 8 shows a greyscale histogram 80 corresponding to the preview image 61. Along the horizontal axis in the grayscale histogram from left to right, the pixel brightness level changes from low to high. Along the vertical axis of the greyscale histogram from top to bottom, the pixel number changes from small to large. In FIG. 7, the region 71 represents that the pixel number corresponding to each pixel brightness level of the pixel brightness levels of the preview image 51 being greater than 230. In FIG. 8, the region 81 represents the pixel number corresponding to each pixel brightness level of the pixel brightness levels of the preview image 61 being greater than 230.

When the resolutions of the preview image 51 and the preview image 61 are 4000×3000, i.e., 12,000,000 pixels, the total pixel number of the first captured image can be denoted as size_{preview}, size_{preview}=12,000,000. In the grayscale histograms of FIG. 7 and FIG. 8, the total height of the vertical axes corresponding to the pixel brightness levels is 12,000,000.

The number of pixels corresponding to each pixel brightness level greater than 230 in the region 71 and the region 81 can be counted, i.e., the height of the vertical axis.

The process of counting the number of pixels size_{overExp7} corresponding to each pixel brightness level greater than 230 in the region 71 can refer to formula (2):

$${size}_{overExp 7} = {Count}_{7} ( {n}_{231} ) + {Count}_{7} ( {n}_{232} ) + … + {Count}_{7} ( {n}_{255} ) \qquad ( 2 )$$

The process of counting the number of pixels size_{overExp8} corresponding to each pixel brightness level greater than 230 in the region 81 can refer to formula (3):

$${size}_{overExp 8} = {Count}_{8} ( {n}_{231} ) + {Count}_{8} ( {n}_{232} ) + … + {Count}_{8} ( {n}_{255} ) \qquad ( 3 )$$

Whether size_{overExp7}/size_{preview} and size_{overExp8}/size_{preview} are greater than 5% can be respectively calculated.

When the target threshold is 5%, with size_{overExp7}/size_{preview} being greater than 5%, the overexposed region in preview image 51 not meeting the trigger condition in the above processing method can be determined. That is, the light source type of light source 52 in preview image 51 may not satisfy the light source type corresponding to the trigger condition. With size_{overExp8}/size_{preview} being greater than 5%, the overexposed region in preview image 61 meeting the trigger condition in the above processing method can be determined. That is, the light source type of light source 62 in preview image 61 may satisfy the light source type corresponding to the trigger condition.

At S403, the processing engine obtains the environment brightness level parameters and sensing parameters of a plurality of consecutive frames of the first captured image.

In some embodiments, a photosensitive assembly can be configured to collect the environment brightness level of the environment where the electronic device is located for 15 consecutive frames of the first captured image.

In some embodiments, a gravity sensor and an accelerometer can be configured to collect the accelerometer parameters and gravity acceleration parameters of the electronic device in the posture corresponding to the 15 consecutive frames of the first captured image, and through a matrix cross multiplication, calculate the pitch angle of the electronic device for each frame.

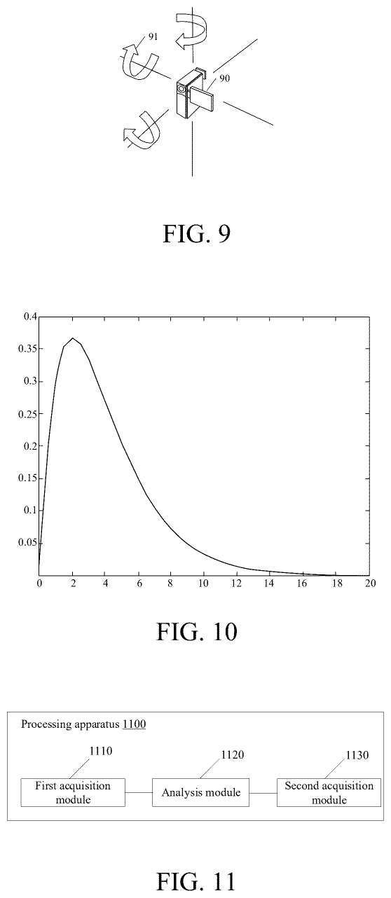

As shown in FIG. 9, the pitch angle is a tilt angle of the electronic device 90 in direction 91.

Exemplarily, the pitch angle can be represented as degreeₚ.

At S404, the image collection application determines the scene type.

Based on the counted overexposed regions in step S402 and the environment brightness level parameters and the sensing parameters of the first captured image collected by the processing engine in step S403, the image collection application can determine the scene type.

In some embodiments, the confidence level of the real scene of the first captured image corresponding to the target scene can be determined by counting the number of frames of the 15 consecutive frames of the first captured image in which the overexposed region ratio is greater than 5%, the number of frames in which the pitch angle of the electronic device is within [−180°, −90° ] and/or [90°, 180° ], and the number of frames in which the environmental illuminance is less than 8 lux.

In some embodiments, a Poisson distribution can be used to determine the confidence level.

As shown in FIG. 10, the Poisson distribution is used to describe the discrete probability distribution of the number of occurrences of random events within a unit time. The horizontal axis in FIG. 10 represents the number of occurrences over time, and the vertical axis represents the probability value corresponding to the number of occurrences.

Exemplarily, the probability function of the Poisson distribution can refer to formula (4):

$$P ( X = k ) = \frac{{λ}^{k}}{k !} {e}^{λ} \qquad ( 4 )$$

where X denotes the type of event, k denotes the number of occurrences of the event, and λ denotes the expected mean and the variance of the Poisson distribution.

Exemplarily, with the Poisson distribution, based on the number of frames a in the 15 consecutive frames of the first captured image in which the overexposed region ratio is greater than 5%, the number of frames b in which the pitch angle of the electronic device is within [−180°, −90° ] and/or [90°, 180° ], and the number of frames c in which the environmental illuminance is less than 8 lux, the process of determining the confidence level conf of the real scene corresponding to the target scene can refer to formula (5):

$$conf = \frac{( \frac{{λ}_{1}^{a}}{a !} {e}^{- {λ}_{1}} + \frac{{λ}_{2}^{b}}{b !} {e}^{- {λ}_{2}} + \frac{{λ}_{3}^{c}}{c !} {e}^{- {λ}_{3}} )}{3} \qquad ( 5 )$$

At S405, the image collection application determines that the scene type of the real scene is the target scene type.

Exemplarily, when the confidence level conf is greater than 0.5, the scene type of the real scene can be determined to be the target scene type to further switch the exposure parameter and display the UI icon of the prompt indicator on the display interface to indicate that the exposure parameter has been switched. When the confidence level conf is less than or equal to 0.5, the scene type of the real scene can be determined to be a non-target scene type, the exposure parameter may not be switched, and the UI icon of the prompt indicator may not be triggered.

At S406, the image collection application calls the processing interface corresponding to the target scene type.

If the called processing interface corresponds to a preview operation, step S407 can be executed. If the called processing interface corresponds to a capturing operation, step S408 to step S409 can be

At S407, the processing engine is configured to collect the preview image using the corresponding image collection channel.

The processing engine, in response to the call information of the processing interface, can be configured to control the image collection apparatus to collect the second captured image using the channel corresponding to the target scene type, and display the preview image based on the second captured image on the display interface.

The image collection channel for collecting the preview image can correspond to the first exposure parameter.

At S408, the image collection application sends a capturing instruction of the real image.

In some embodiments, the image collection application can send the collection instruction for the real image to the processing engine via the corresponding processing interface.

At S409, the processing engine is configured to collect the real image via the corresponding image collection channel.

The real image can be the image obtained by capturing the real scene corresponding to the preview image based on the second captured image.

The image collection channel for capturing the real image can correspond to the second exposure parameter.

In embodiments of the present disclosure, by obtaining the plurality of consecutive frames of the first captured image, the scene type of the real scene corresponding to the first captured image can be determined to further adjust the exposure parameter when the real scene corresponds to the target scene type. Then, when the scene captured by the user includes a large bright region (e.g., a point light source), the exposure parameter can be automatically adjusted according to the photographing scene to reduce the overexposure of the image captured by the user and improve the user photographing experience.

Embodiments of the present disclosure provide a processing apparatus. As shown in FIG. 11, the processing apparatus 1100 includes a first acquisition module 1110, an analysis module 1120, and a second acquisition module 1130.

The first acquisition module 1110 can be configured to obtain the first captured image through the image collection apparatus based on the first exposure parameter. The first captured image can represent the real scene.

The analysis module 1120 can be configured to analyze the first captured image.

The second acquisition module 1130 can be configured to, if the analysis result of the first captured image satisfies the trigger condition, obtain the second captured image through the image collection apparatus based on the second exposure parameter. The second captured image can represent the real scene.

The preview image based on the first captured image can be displayed on the display screen to represent the real scene with the first brightness level.

The preview image based on the second captured image can be displayed on the display screen to represent the real scene with the second brightness level.

The second brightness level can be less than the first brightness level, and the brightness level of the display screen can remain unchanged.

In some embodiments, the analysis module can be further configured to count the brightness level of each pixel of the first captured image and obtain the number of pixels of different brightness levels of the first captured image.

In some embodiments, the analysis result of the first captured image satisfying the trigger condition can include that the first captured image includes target pixels greater than the target brightness level, and the ratio of the target pixels to the pixels of the first captured image is greater than the target threshold.

In some embodiments, the processing apparatus can further include a first determination module configured to determine the second exposure parameter based on the average brightness level of the target pixels greater than the target brightness level. When the average brightness level of the target pixels greater than the target brightness level is different, the value of the second exposure parameter can be different.

In some embodiments, the processing apparatus can also include a third acquisition module configured to perform at least one of obtaining the sensing parameter characterizing the posture of the electronic device when the image collection apparatus obtains the first captured image based on the first exposure parameter, the trigger condition further including that the sensing parameter meets the sensing threshold and the electronic device including the image collection apparatus, or the obtaining environment brightness level parameter characterizing the posture of the electronic device when the image collection apparatus obtains the first captured image based on the first exposure parameter, the trigger condition further including that the environment brightness level parameter meets the environment brightness level threshold and the environment brightness level parameter being used to determine the brightness level of the display screen.

In some embodiments, the first acquisition module can also be configured to continuously obtain the target number of frames of the first captured image through the image collection apparatus based on the first exposure parameter.

The processing apparatus can further include a second determination module, configured to determine the confidence level based on the determination result of the trigger condition corresponding to each frame of the target number of frames of the first captured image.

The second acquisition module can further be configured to, in response to the confidence level being greater than the target value, obtain the second captured image through the image collection apparatus based on the second exposure parameter. When the confidence level is greater than the target value, photographing of the real scene can be indicated to be in the stable state.

In some embodiments, the processing apparatus can also include a display module, configured to, in response to the confidence level being greater than the target value, display the prompt indicator. The prompt indicator can be used to indicate that the photographing of the real scene belongs to the target photographing scene.

The processing apparatus can further include a turn-off module, configured to, in response to the input operation for the prompt indicator, turn off obtaining the second captured image by the image collection apparatus based on the second exposure parameter.

Embodiments of the present disclosure further provide a computer program, including computer-readable codes. When the computer-readable codes are executed in the computer device, the processor of the computer device can execute a part of or all steps in the processing method.

Embodiments of the present disclosure further provide a computer program product, including a computer program or an instruction. When the computer program or instruction is executed by the processor, the processor can execute a part of or all steps in the processing method.

Embodiments of the present disclosure further provide a computer-readable storage medium storing a computer program that, when executed by the processor, causes the processor to execute the processing method.

The present disclosure can be described with reference to flowcharts and/or block diagrams of the method, apparatus, and electronic device according to embodiments of the present disclosure. Each process and/or block in the flowcharts and/or block diagrams and a combination of the processes and/or blocks in the flowcharts and/or block diagrams can be implemented by the computer program instruction. The computer program instructions can be provided to a processor of a general-purpose computer, a special-purpose computer, an embedded processor, or other programmable data processing devices to produce a machine. Then, the instruction executed by the processor of the computer or other programmable data processing device can produce an apparatus configured to realize the functions indicated by the one or more processes in the flowchart and/or one or more blocks of the block diagram.

The computer program instructions can also be stored in a computer-readable memory that can guide the computer or other programmable data processing device to cause the instructions stored in the computer-readable memory to produce a product including the instruction apparatus. The instruction apparatus can be configured to realize the function indicated in one or more processes of the flowchart and/or one or more blocks in the block diagram.

The computer program instructions can also be loaded onto the computer or other programmable data processing devices to allow the computer or other programmable devices to perform a series of operation steps on the computer or other programmable devices to produce processing realized by the computer. Then, the instructions executed on the computer or other programmable devices can provide the steps of the functions indicated in the one or more processes of the flowchart and/or one or more blocks of the block diagram.

The above are merely some embodiments of the present disclosure. However, the scope of the present disclosure is not limited to this. Those skilled in the art can easily think of modifications or replacements in the technology of the present disclosure, which should be within the scope of the present disclosure.

The description of apparatus embodiments can be similar to the description of method embodiments and can have a similar beneficial effect as method embodiments. For the technical details of embodiments of the present disclosure, reference can be made to the description of method embodiments of the present disclosure.

“One embodiment” or “an embodiment” mentioned in the present disclosure means that specific features, structures, or characteristics related to the embodiment can be included in at least one embodiment of the present disclosure. Therefore, the phrases “in one embodiment” or “in an embodiment” appearing throughout the specification do not necessarily refer to the same embodiment. In addition, these specific features, structures, or characteristics can be combined in one or more embodiments in any suitable manner. In various embodiments of the present disclosure, the numerical order of the above processes does not imply the order of execution. The execution order of the processes should be determined according to the functions and internal logic of embodiments of the present disclosure and should not impose any limitation on the implementation process of embodiments of the present disclosure. The numerical order of embodiments in the present disclosure is only for description and does not represent the advantages or disadvantages of the embodiments.

In the present disclosure, the terms “comprising,” “including,” or any other variants can be intended to cover non-exclusive inclusion, so that a process, method, item, or apparatus that includes a series of elements not only includes those elements but also includes other elements not explicitly listed, or elements inherent to such a process, method, item, or apparatus. Without further limitation, an element defined by the statement “including one . . . ” does not exclude the existence of additional identical elements in the process, method, item, or apparatus including the element.

In embodiments of the present disclosure, it should be understood that the disclosed device and method can be implemented by other means. The above-described device embodiments are only illustrative. For example, the division of the unit is only a logical function division. In actual implementation, other division methods can be provided. For example, a plurality of units or assemblies can be combined, or integrated into another system, or some features can be ignored or not executed. In addition, the coupling, direct coupling, or communication connection between the components shown or discussed can be via indirect coupling or communication connection between some interfaces, devices, or units, which can be electrical or mechanical.

The units described as separate members may or may not be physically separate. The members displayed as units may or may not be physical units. The members can be located in one place or distributed across a plurality of network units. Some or all units can be selected according to actual needs to achieve the purpose of embodiments of the present disclosure.

Moreover, in embodiments of the present disclosure, the functional units can all be integrated into a single processing unit, each unit may independently function as a separate unit, or two or more units may be integrated into one unit. The integrated unit can be implemented in the hardware form or in a combination of hardware and software functional units.

Those skilled in the art can understand that all or part of the steps of the above method embodiments can be performed by hardware related to program instructions. The above described program can be stored in a computer-readable storage medium that, when executed, causes the processor to perform the steps of the above method embodiments. The storage medium can include mobile storage devices, Read Only Memory (ROM), disks, optical disks, or various other media capable of storing program codes.

In some other embodiments, when the integrated units mentioned above are implemented in the form of software functional modules and sold or used as independent products, the integrated units can also be stored in the computer-readable storage medium. Based on this understanding, the technical solutions of embodiments of the present disclosure in essence or a part of the technical solutions contributing to related technology can be realized in the form of a software product. The computer software product can be stored on a storage medium and include several instructions to enable a computer device (e.g., a personal computer, server, or network device, etc.) to execute all or a part of the method of embodiments of the present disclosure. The storage medium can include mobile storage devices, ROM, disks, optical disks, or various media capable of storing program codes.

The above can be only embodiments of the present disclosure. However, the protection scope of the present disclosure is not limited to this. Those skilled in the art can easily think of modifications or replacements, which should be within the scope of the present disclosure.

What is claimed is:

1. A processing method comprising:
obtaining a first captured image through an image collection apparatus based on a first exposure parameter, the first captured image representing a real scene;
analyzing the first captured image;
in response to an analysis result of the first captured image satisfying a trigger condition, obtaining a second captured image through the image collection apparatus based on a second exposure parameter, the second captured image representing the real scene;
wherein:
a preview image based on the first captured image is displayed on a display screen to show the real scene and present a first brightness level;
a preview image based on the second captured image is displayed on the display screen to show the real scene and present a second brightness level; and
the second brightness level is less than the first brightness level.

2. The method according to claim 1, wherein analyzing the first captured image includes:
counting a brightness level of each pixel of the first captured image; and
obtaining a number of pixels at different brightness levels of the first captured image.

3. The method according to claim 2, wherein the analysis result of the first captured image satisfying the trigger condition includes:
the first captured image includes target pixels having a brightness level greater than a target brightness level, and a ratio of the target pixels to pixels of the first captured image is greater than a target threshold.

4. The method according to claim 2, further comprising:
determining the second exposure parameter based on an average brightness level of the target pixels having brightness levels greater than the target brightness level;
wherein in response to the average brightness level of the target pixels having the brightness levels greater than the target brightness level being different, a value of the second exposure parameter is different.

5. The method according to claim 1, further comprising at least one of:
obtaining a sensing parameter indicating a posture of an electronic device when the image collection apparatus obtains the first captured image based on the first exposure parameter, the trigger condition further including that the sensing parameter satisfies a sensing threshold, and the electronic device including the image collection apparatus; or
obtaining an environment brightness level parameter indicating the posture of the electronic device when the image collection apparatus obtains the first captured image based on the first exposure parameter, wherein the trigger condition further including that the environment brightness level parameter satisfies an environment brightness level threshold, and the environment brightness level parameter is used to determine a brightness level of the display screen.

6. The method according to claim 5,
wherein obtaining the first captured image through the image collection apparatus based on the first exposure parameter includes continuously obtaining a target number of frames of the first captured image through the image collection apparatus based on the first exposure parameter;
before obtaining the second captured image through the image collection apparatus based on the second exposure parameter, the method further comprising determining a confidence level based on a determination result of the trigger condition corresponding to each frame of the target number of frames of the first captured image;
wherein obtaining the second captured image through the image collection apparatus based on the second exposure parameter includes:
in response to the confidence level being greater than a target value, obtaining the second captured image through the image collection apparatus based on the second exposure parameter, the confidence level greater than the target value indicating that photographing of the real scene is in a stable state.

7. The method according to claim 6, further comprising:
in response to the confidence level being greater than the target value, displaying a prompt indicator, the prompt indicator being used to indicate that the photographing of the real scene belongs to a target photographing scene; and
in response to an input operation for the prompt indicator, turning off obtaining the second captured image through the image collection apparatus based on the second exposure parameter.

8. An electronic device comprising:
a camera configured to capture an image;
a display screen configured to output and display; and
a processor configured to control the camera to obtain a first captured image based on a first exposure parameter, the first captured image representing a real scene, analyze the first captured image, and in response to an analysis result of the first captured image satisfying a trigger condition, obtain a second captured image through the camera based on a second exposure parameter, the second captured image representing the real scene;
wherein:
a preview image based on the first captured image is displayed on a display screen to show the real scene and present a first brightness level;
a preview image based on the second captured image is displayed on the display screen to show the real scene and present a second brightness level; and
the second brightness level is less than the first brightness level.

9. The electronic device according to claim 8, wherein the processor is further configured to:
count a brightness level of each pixel of the first captured image; and
obtain a number of pixels at different brightness levels of the first captured image.

10. The electronic device according to claim 9, wherein the analysis result of the first captured image satisfying the trigger condition includes:
the first captured image includes target pixels having a brightness level greater than a target brightness level, and a ratio of the target pixels to pixels of the first captured image is greater than a target threshold.

11. The electronic device according to claim 9, wherein the processor is further configured to:
determine the second exposure parameter based on an average brightness level of the target pixels having brightness levels greater than the target brightness level;
wherein in response to the average brightness level of the target pixels having the brightness levels greater than the target brightness level being different, a value of the second exposure parameter is different.

12. The electronic device according to claim 8, wherein the processor is further configured to perform at least one of:
obtaining a sensing parameter indicating a posture of an electronic device when the camera obtains the first captured image based on the first exposure parameter, the trigger condition further including that the sensing parameter satisfies a sensing threshold, and the electronic device including the camera; or
obtaining an environment brightness level parameter indicating the posture of the electronic device when the camera obtains the first captured image based on the first exposure parameter, wherein the trigger condition further including that the environment brightness level parameter satisfies an environment brightness level threshold, and the environment brightness level parameter being used to determine a brightness level of the display screen.

13. The electronic device according to claim 12, wherein the processor is further configured to:
continuously obtain a target number of frames of the first captured image through the camera based on the first exposure parameter;
determine a confidence level based on a determination result of the trigger condition corresponding to each frame of the target number of frames of the first captured image;
in response to the confidence level being greater than a target value, obtain the second captured image through the camera based on the second exposure parameter, the confidence level greater than the target value indicating that photographing of the real scene is in a stable state.

14. The electronic device according to claim 13, wherein the processor is further configured to:
in response to the confidence level being greater than the target value, display a prompt indicator, the prompt indicator being used to indicate that the photographing of the real scene belongs to a target photographing scene; and
in response to an input operation for the prompt indicator, turn off obtaining the second captured image through the camera based on the second exposure parameter.

15. A computer-readable storage medium storing one or more computer programs that, when executed by one or more processors, causes the one or more processors to:
obtain a first captured image based on a first exposure parameter, the first captured image representing a real scene;
analyze the first captured image; and
in response to an analysis result of the first captured image satisfying a trigger condition, obtain a second captured image through the image collection apparatus based on a second exposure parameter, the second captured image representing the real scene;
wherein:
a preview image based on the first captured image is displayed on a display screen to show the real scene and present a first brightness level;
a preview image based on the second captured image is displayed on the display screen to show the real scene and present a second brightness level; and
the second brightness level is less than the first brightness level.

16. The computer-readable storage medium according to claim 15, wherein one or more processors are further configured to:
count a brightness level of each pixel of the first captured image; and
obtain a number of pixels at different brightness levels of the first captured image.

17. The computer-readable storage medium according to claim 16, wherein the analysis result of the first captured image satisfying the trigger condition includes:
the first captured image includes target pixels having a brightness level greater than a target brightness level, and a ratio of the target pixels to pixels of the first captured image is greater than a target threshold.

18. The computer-readable storage medium according to claim 16, wherein one or more processors are further configured to:
determine the second exposure parameter based on an average brightness level of the target pixels having brightness levels greater than the target brightness level;
wherein in response to the average brightness level of the target pixels having the brightness levels greater than the target brightness level being different, a value of the second exposure parameter is different.

19. The computer-readable storage medium according to claim 15, wherein one or more processors are further configured to perform at least one of:
obtaining a sensing parameter indicating a posture of an electronic device when the image collection apparatus obtains the first captured image based on the first exposure parameter, the trigger condition further including that the sensing parameter satisfies a sensing threshold, and the electronic device including the image collection apparatus; or
obtaining an environment brightness level parameter indicating the posture of the electronic device when the image collection apparatus obtains the first captured image based on the first exposure parameter, wherein the trigger condition further includes that the environment brightness level parameter satisfies an environment brightness level threshold, and the environment brightness level parameter is used to determine a brightness level of the display screen.

20. The computer-readable storage medium according to claim 19, wherein one or more processors are further configured to:
continuously obtain a target number of frames of the first captured image through the image collection apparatus based on the first exposure parameter;
determine a confidence level based on a determination result of the trigger condition corresponding to each frame of the target number of frames of the first captured image;
in response to the confidence level being greater than a target value, obtain the second captured image through the image collection apparatus based on the second exposure parameter, the confidence level greater than the target value indicating that photographing of the real scene is in a stable state.
